(19) United States
(12) Patent Application Publication
(10) Pub. No.: US 2018/0319085 A1
(43) Pub. Date: Nov. 8, 2018

(54) SYSTEM AND METHODS FOR ADDITIVE MANUFACTURING DEPOSITION AND ROUTING BASED ON PART PERFORMANCE

(71) Applicant: SABIC Global Technologies B.V., Bergen op Zoom (NL)

(72) Inventor: Prasad DASAPPA, Bangalore (IN)

(21) Appl. No.: 15/773,118

(22) PCT Filed: Nov. 4, 2016
(86) PCT No.: PCT/IB2016/056659

§ 371 Date: May 2, 2018

Related U.S. Application Data
(60) Provisional application No. 62/251,880, filed on Nov. 6, 2015.

(51) Int. Cl. B29C 64/386; B33Y 50/02; B33Y 10/00

(52) U.S. Cl. CPC B29C 64/386; B29C 64/106; B33Y 10/00; B33Y 50/02

(57) ABSTRACT

A manufacturing method and system is described. The method includes, in one aspect: generating print location instructions for a part to be printed; determining a printing direction for the part or elements of the part by analyzing a direction of maximum principal stress for elements of the part to be printed subject to tension under the load and a direction of minimum principal stress for elements of the part to be printed subject to compression under the load; generating print direction instructions for the part, the print direction instructions including instructions to print the part in the determined printing direction; and printing the part in a manufacturing system in accordance with the print location instructions and print direction instructions.

### FIELD OF DISCLOSURE

The present disclosure relates to additive manufacturing methods and systems, and more particularly to additive manufacturing methods and systems that produce parts based on matching various criteria for part performance.

### BACKGROUND OF THE DISCLOSURE

Three dimensional (3D) printers, commonly referred to as additive manufacturing systems, use polymeric, composite or other materials to build a part, generally one layer at a time. The material is heated and liquefied/melted and then drawn through a print head and nozzle of the printer onto the print surface, commonly referred to as the print bed. Some additive manufacturing systems include two or more print heads and nozzles. Once applied to the print bed, the liquefied material solidifies quickly, sealing itself to adjoining printed material. In some examples, the print head and nozzle is moveable in the X and Y directions (i.e., forward and backward, and left and right, respectively) and the print bed is moveable in the Z direction (i.e., up and down) as the material is drawn through the print head and nozzle. In this manner, the print bed and print head(s)/nozzle(s) work together to print in three dimensions.

The various additive manufacturing systems in use today result in parts with less tensile strength or stiffness than in comparison to parts produced through traditional manufacturing methods, due to the additive printing methods described above that do not take into account the strength and/or stiffness requirements of the parts. This lack of strength and/or stiffness has hindered the widespread adoption of additive manufacturing systems in manufacturing practices.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a flowchart illustrating an additive manufacturing method according to aspects described herein.

FIG. 2A is a top perspective view of a part to be printed showing displacement of the part in response to the load applied thereto.

FIG. 2B is a bottom perspective view of a part to be printed having a load applied thereto in a finite element analysis program.

FIG. 2C is a top perspective view of the part to be printed as meshed in a finite element analysis and showing the part broken into individual elements.

FIG. 3 is a top perspective view of a part to be printed showing elements of tension and compression under the load.

FIG. 4 is a flowchart illustrating a method for generating print location instructions.

FIG. 5 is a graph providing stress-strain curves for a composite material subject to tension and compression.

FIG. 6 is a top perspective view of a stress analysis for the part showing the relative mapped direction of printing based on direction of maximum principal stresses for elements of the part to be printed under tension and compression.

FIG. 6A is a top perspective view of a stress analysis for the part showing a dissected view of the relative mapped direction of printing based on direction of maximum principal stresses for elements of the part to be printed under tension and compression.

FIGS. 7A-C illustrate processes for determining a direction of maximum principal stress for an element of the part.

FIGS. 8A and 8B are top perspective views of the part to be printed showing the printing direction for the part.

FIGS. 9A and 9B illustrate an aspect for generating print direction instructions that includes slicing the part to be printed into slices along the printing direction for the part.

FIGS. 10A-C illustrate exemplary additive manufacturing systems for use with the additive manufacturing methods described herein.

FIGS. 11A and 11B illustrate simulated elements of tension and compression and printing directions for an exemplary spring as the printed part.

FIGS. 12A-C illustrate several exemplary methods for incorporating a continuous fiber into an exemplary spring as the printed part.

FIG. 13 provides exemplary force/displacement curves for an exemplary spring having continuous fiber incorporated therein.

FIGS. 14A-D illustrate a method for determining the printing direction of a part so as to maximize its strength and/or stiffness.

FIGS. 15A-C are top perspective views of a part to be printed showing displacement of the part in response to a load applied thereto, each part including different materials.

### SUMMARY

Aspects of the disclosure relate to an additive manufacturing method for manufacturing a printed part. In certain aspects the method includes: generating print location instructions for the part; determining a printing direction for the part or elements of the part; generating print direction instructions for the part; and printing the part in an additive manufacturing system in accordance with the print location instructions and print direction instructions. The print location instructions include instructions to apply a tensile material to elements of the part corresponding to elements of a part to be printed subject to tension under a load, and instructions to apply at least a base material to other elements of the part (including those elements subject to compression under the load). The printing direction is determined by analyzing the direction of maximum principal stress for elements of the part to be printed subject to tension under the load and analyzing a direction of minimum principal stress for elements of the part to be printed subject to compression under the load. The print direction instructions include instructions to print the part or elements of the part in the determined printing direction.

### DETAILED DESCRIPTION

Aspects of the disclosure will now be described in detail with reference to the figures, wherein like reference numerals designate identical or corresponding parts throughout the several views, unless specified otherwise.

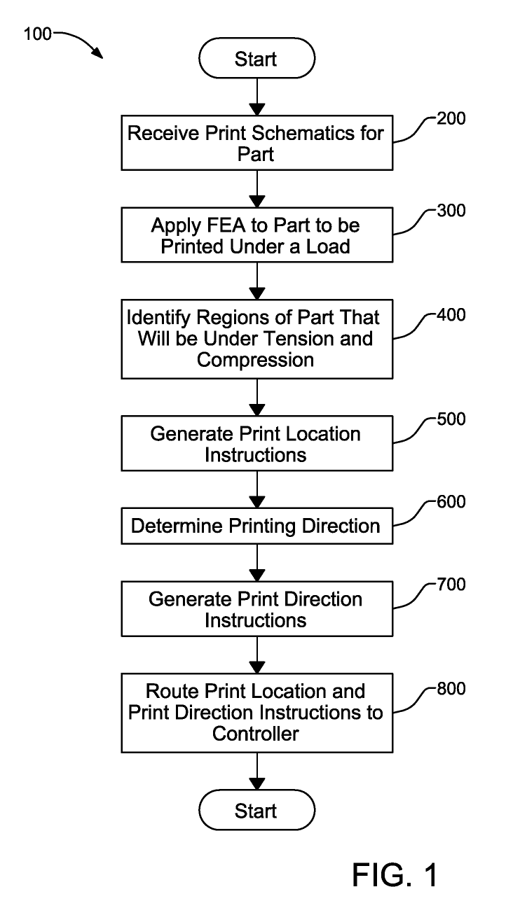

Aspects described herein relate to an additive manufacturing method 100 for manufacturing a printed part 10. As illustrated in FIG. 1, in one aspect the manufacturing method 100 includes receiving print schematics for the part to be printed 200, applying a finite element analysis to the part to be printed under a load 300, identifying elements of the part subject to tension and compression under the load 400, generating print location instructions for the part 500, determining a printing direction for the part or elements of the part 600, generating print direction instructions for the part 700, and routing the print location instructions 500 and print direction instructions 700 to a controller of an additive manufacturing system.

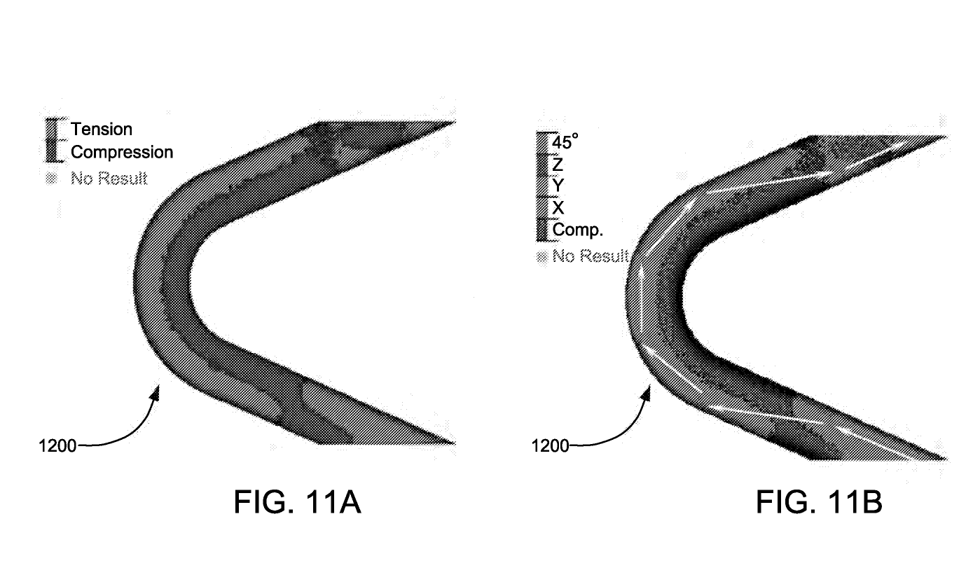

The additive manufacturing system 1000 is described in more detail below, but as shown in FIG. 10A it generally includes a print bed 1010 onto which a printed part 10 is formed and a print head/nozzle system 1020 that provides the material onto the print bed that forms the printed part 10. The print head/nozzle system 1020 includes at least one print head and nozzle 1030; as illustrated in FIG. 10A the print head/nozzle system includes two print heads and nozzles 1030, 1040. The print head/nozzle system 1020 is configured to apply at least two materials onto the print bed 1010, a tensile material 1050 and a base material 1060, according to the print location instructions 500. As discussed above, print location instructions 500 and print direction instructions 700 are routed 800 to the controller 1070, and the controller 1070 operates a physical control system 1080 that moves the print head/nozzle system 1020 relative to the print bed 1010. In this manner, the print bed 1010, print head/nozzle system 1020, controller 1070 and physical control system 1080 operate to form the printed part 10 from the materials.

Individual aspects of the additive manufacturing method 100 will now be described in further detail. It will be recognized that the acts in the method can be performed using a finite element analysis or other system that include, for example, a computer system integrated into an additive manufacturing system 1000 or separate from the additive manufacturing system 1000.

In one aspect, the manufacturing method includes an act 200 of receiving print schematics for the part to be printed. For instance, the act 200 can include receiving information from a customer that includes schematics, diagrams, specifications or other data that would allow the additive manufacturing system 1000 to form the printed part 10. The print schematics include standard information that is known in the art, and in some aspects are provided as a 3D computer-aided design (CAD) stereolithography (STL) file format or 2D CAD file which is converted into an STL file format.

Based on the print schematics, at 300, a finite element analysis is performed on the part to be printed 310 under a load. Generally, finite element analysis involves predicting how a part reacts to real-world forces, heat, vibration, fluid flow or other physical aspects. Finite element analysis can be used to evaluate whether a component will break, wear out, or perform in the manner in which it was designed. Further, finite element analyses are typically used to determine the structural performance of the component. The finite element analysis is performed by meshing the component (i.e., dividing it into elements), assigning materials to each of the elements, applying boundary conditions to the component, applying the load(s), and applying the finite element analysis using a software program, such as but not limited to Abaqus® and Ansys®.

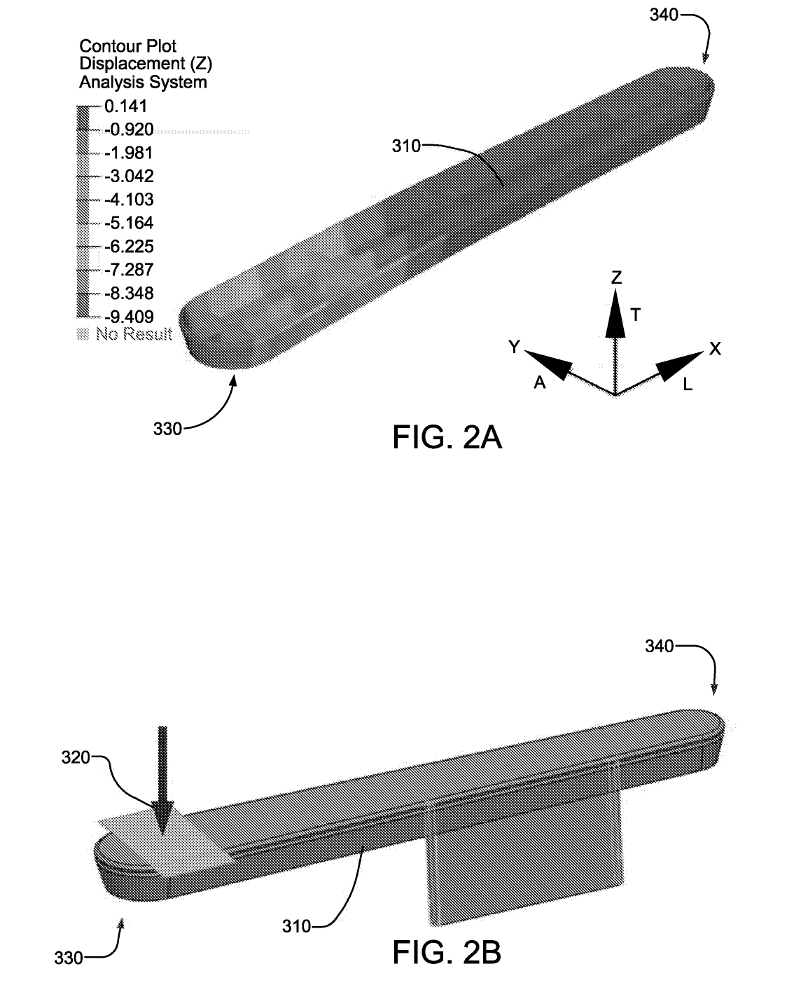

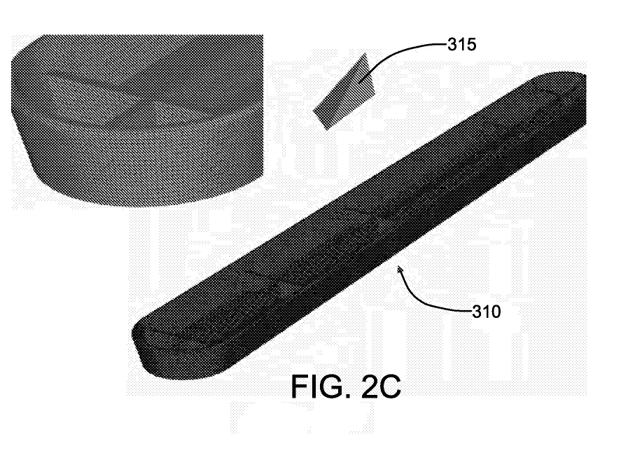

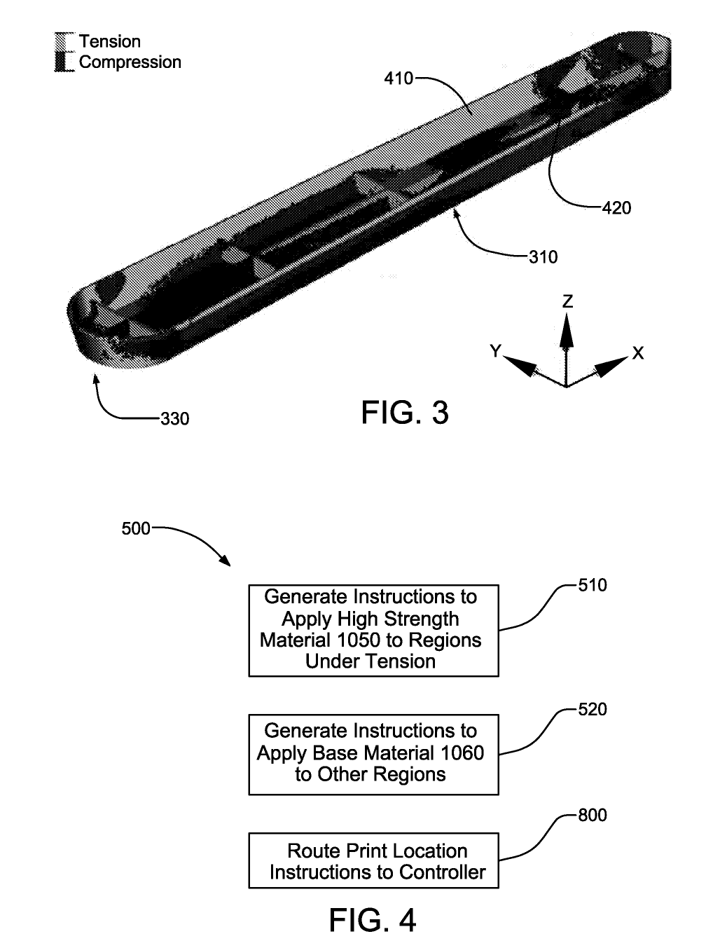

For the purposes of the present disclosure, the part to be printed 310 is located in a three-dimensional coordinate system having an X-axis, Y-axis and Z-axis that are all perpendicular to one another. As shown in FIG. 2A, the part to be printed 310 includes a longitudinal direction (length) L aligned in the direction of the X-axis, a lateral direction (width A) aligned in the direction of the Y-axis, and a transverse direction (height) T aligned in the direction of the Z-axis. The part to be printed 310 includes a first end 330 and a second end 340 aligned in longitudinal direction L along the X-axis.

In aspects described herein, finite element analysis is generally used to determine how the part to be printed 310 would react to a load 320 (e.g., 100 Newtons (N)) applied to the first end 330 of the part to be printed 310, as illustrated in FIG. 2B. As illustrated in FIG. 2B, the load 320 is applied to the part to be printed 310 perpendicular to the first end 330 along the transverse direction T (i.e., the load 320 pushes down on the part to be printed 310 in the direction of the Z axis). It will be appreciated, however, that the load 320 need not be applied to the part to be printed 310 perpendicular to the first end 330 and can be applied elsewhere on the part to be printed 310 or in other directions (or even multiple loads could be applied); the displacement analysis would show different results if the direction and/or location of the load 320 or the number of loads were changed. In a particular aspect, the load 320 could be applied to the part to be printed 310 to correspond to loads that are expected to be applied to the printed part 10 during use.

A displacement analysis of the part to be printed 310 that is produced from the finite element analysis is shown in FIG. 2A. The displacement analysis identifies a predicted amount of displacement of the first end 330 of the part to be printed 310 with respect to the second end 340 along the X direction, after the load 320 was applied to the first end 330.

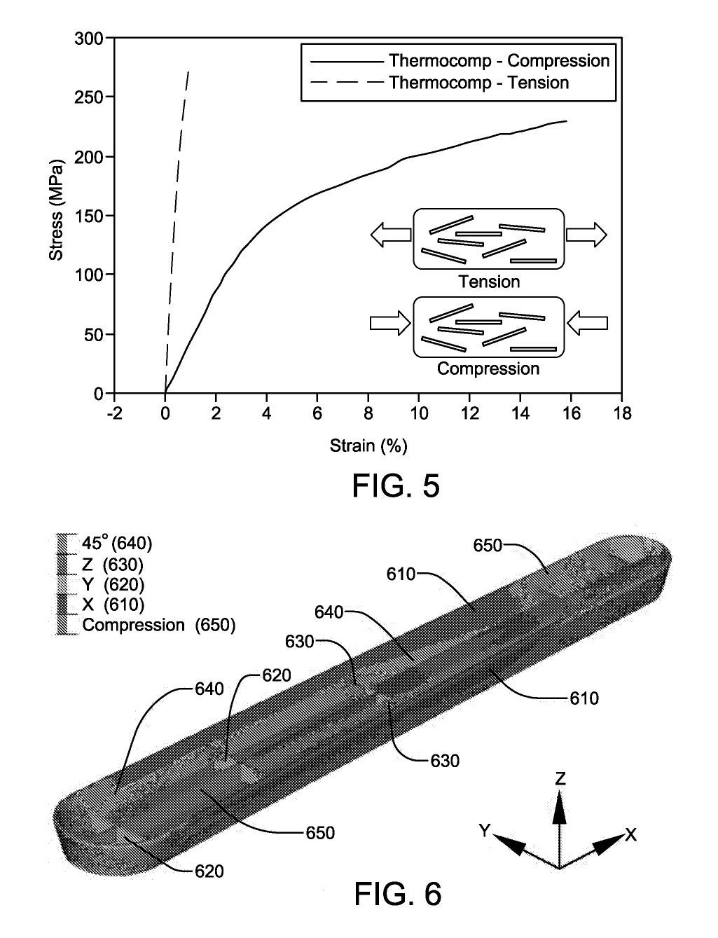

As explained above, aspects of the method include, at 400, identifying elements of the part to be printed 310 under tension and compression. For instance, FIG. 3 illustrates elements of the part to be printed 310 subject to tension 410 and compression 420 after the load 320 has been applied to the first end 330. As illustrated, lighter areas show elements under tension 410 and darker areas show elements under compression 420.

The process for applying a finite element analysis to the part to be printed 310 can be further described with reference to FIG. 2C, which illustrates the part to be printed 310 after meshing (i.e., after having been divided into elements). An exemplary element 315 is illustrated as a pyramid-shaped object having a micro volume, although the part to be printed 310 could be meshed into elements 315 having other shapes and sizes as desired. The finite element analysis software, such as Abaqus®, analyzes each element 315 to determine displacement, stress, strain and other structural outputs on the element based on the applied load 320. A user-defined subroutine executed in the software identifies elements 315 under tension 410 and compression 420.

When elements under tension 410 and compression 420 have been identified at act 400, the method 100 includes, at 500, generating print location instructions for the part to be printed. Generally, print location instructions include instructions for applying a specified material to a specified region of the part as the part is printed. As used herein, a region is a volume of the part on which the specified material is applied. The size of the region will thus be a related to the thickness of the layer being formed by the additive manufacturing system and the amount of material being applied to the layer at the point the material is applied thereto. Layer thickness can vary widely from one additive manufacturing system to another, but in some aspects can be from about 10 microns (pm) to several millimeters or even inches thick.

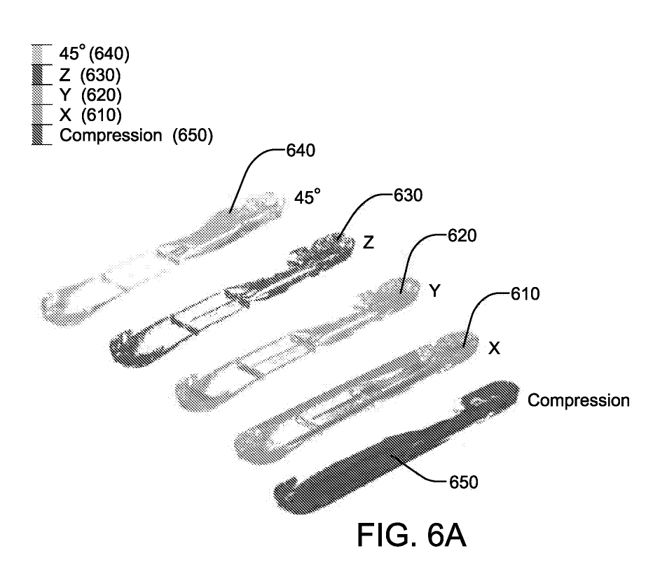

As illustrated in further detail in FIG. 4, in one aspect the act of generating print location instructions 500 includes an act 510 of generating instructions to apply, or print, a tensile material 1050 to elements of the part corresponding to elements of the part to be printed 310 subject to tension 410 under the load 320. After the instructions have been generated at act 510, the method 500 includes an act 520 of generating instructions to apply at least a base material 1060 to other elements of the part. Other elements are elements other than those subject to tension 410, and include elements subject to compression 420 and, if applicable, elements that are not subject to either tension 410 or compression 420. In some aspects, the act of generating print location instructions 500 includes an act 510 of generating instructions to apply, or print, a tensile material 1050 to elements of the part corresponding to elements of the part to be printed 310 subject to compression 420 under the load 320 in addition to applying the tensile material 1050 to elements of the part corresponding to elements of the part to be printed 310 subject to tension 410 under the load 320. After the print locations have been generated, the method includes an act 800 of routing the print location instructions 500 to the controller 1070 of the additive manufacturing system 1000.

As explained herein, in one aspect instructions are generated for the additive manufacturing system 1000 to apply the tensile material 1050 to elements of the printed part 10 under tension 410 (and optionally under compression 420) and a base material 1060 to other elements of the printed part 10. As used herein, base material 1060 is a material that is typically used as the primary material in current additive manufacturing and other applications. For example, base material 1060 can be a “neat polymer,” which is a concentrated liquid or polymer as-supplied from the manufacturer. Exemplary base materials 1060 include, but are not limited to, polymeric materials, metallic materials, ceramic materials and combinations thereof. Exemplary polymeric materials include but are not limited to polycarbonate, nylon, amorphous thermoplastic polyetherimide (PEI) resin, semi-crystalline thermoplastic and combinations thereof. Exemplary metallic materials include but are not limited to aluminum and magnesium. Exemplary ceramic materials include but are not limited to silicon carbide (SiC), alumina (Al₂O₃) and mullite (Al₂O₃SiO₂). One such amorphous thermoplastic PEI resin is Ultem™ resin, available from SABIC. In other aspects, the base material 1060 could be a composite such as those described below for the tensile material 1050, although such a base material would typically include less of the composite material than the tensile material 1050 to reduce the cost of the printed part 10. The base material 1060 generally has a lower strength and/or stiffness than the tensile material 1050. One exemplary composite base material 1060 could be glass-filled Ultem™ resin, which is cheaper than a comparable carbon-fiber filled material but which also has a lower strength and/or stiffness than the carbon-fiber filled material.

Tensile material 1050 is a material having a relatively higher tensile strength and/or stiffness than the base material 1060. Exemplary, but by no means limiting, tensile materials 1050 include composite materials such as carbon fibers, glass fibers, glass beads, metal fibers, metal beads, powder, or combinations thereof, in a substrate material. Exemplary substrate materials include, but are not limited to, polymeric materials, metallic materials, ceramic materials and combinations thereof. Exemplary polymeric materials include but are not limited to polycarbonate, nylon, amorphous thermoplastic polyetherimide (PEI) resin, semi-crystalline thermoplastic and combinations thereof. Exemplary metallic materials include but are not limited to aluminum and magnesium. Exemplary ceramic materials include but are not limited to silicon carbide (SiC), alumina (Al₂O₃) and mullite (Al₂O₃SiO₂). In other aspects, the tensile material 1050 is a material other than a composite, such as a thermoplastic or other material having a higher strength or stiffness than the base material 1060. Exemplary tensile materials 1050 that need not be composites include, but are not limited to, acrylonitrile butadiene styrene (ABS) polymer, metal (e.g., metal filament), glass (e.g., glass filament) or combinations thereof. In one particular aspect, the tensile material 1050 is a composite including carbon fibers or glass fibers in a PEI resin matrix, and the base material 1060 is a PEI resin.

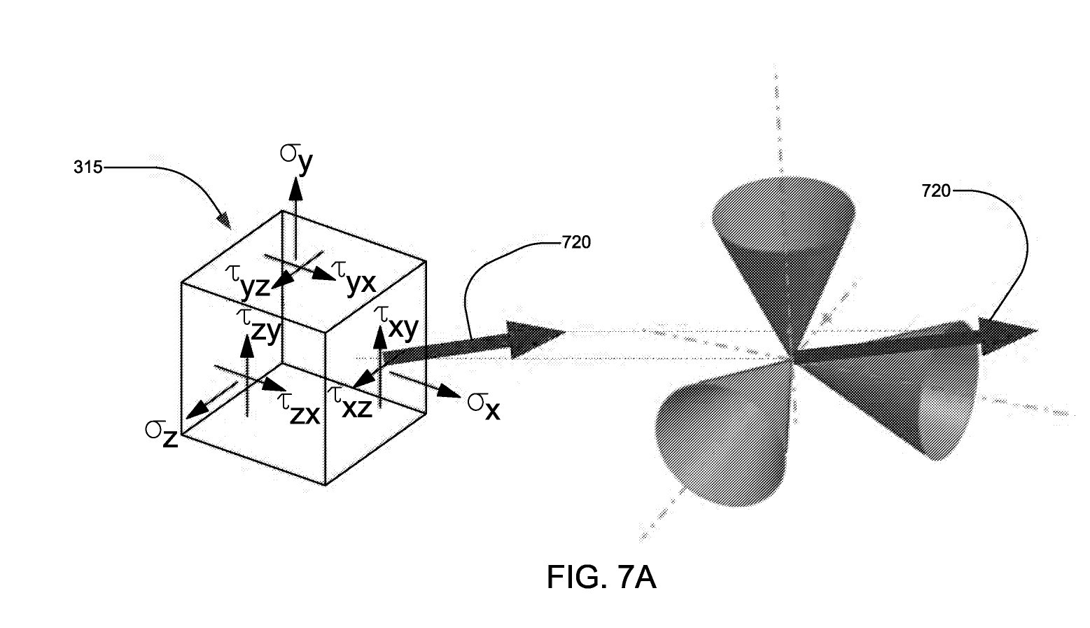

Composite materials such as those described herein, which can have, e.g., carbon fibers or glass fibers in a substrate material, generally provide more strength and/or stiffness to molded parts than materials that include only a polymeric base material and no fibers included therein. It has also been found that the strength and/or stiffness of such composite materials is higher when the material is in tension than when in compression. See, e.g., FIG. 5, which provides exemplary stress-strain curve data for a Thermocomp™ composite compound (30% carbon fiber filled Ultem™ resin), available from SABIC, when tested under both compression and tension. As evidenced from the curve, the composite material is substantially stronger and has a higher stiffness under tension than compression. It is for at least this reason that aspects of the method described herein and illustrated in FIGS. 1 and 4 include generating print location instructions 500 that include, at 510, instructions for applying a tensile material 1050 to elements of the printed part 10 corresponding to elements of the part to be printed 310 subject to tension 410 under the load 320, and, at 520, instructions to apply at least a base material 1060 to other elements of the printed part 10, including those elements subject to compression 420 under the load 320. While aspects described herein refer to applying at least a base material 1060 to other elements of the printed part 10 (e.g., elements of the part under compression or elements not under compression or tension), it will be recognized that in addition to the base material 1060, a tensile material 1050 can be applied to one or more of these elements. Applying a tensile material in elements of the printed part 10 not under tension can enhance the overall strength and/or stiffness of the part, but may not be necessary and would increase the overall cost of the printed part 10, as tensile materials 1050 are generally more costly than the base material 1060. Thus, in some aspects the tensile material 1050 can be applied only in those elements of the printed part 10 where it would have the greatest effect in performance improvement, i.e., those elements under tension and optionally compression. Higher performance is indicated by various factors, including but not limited to lower deformation and lower stresses.

As described above and with reference to FIG. 1, the method 100 can include, at 600, the act of determining a printing direction for the part or elements of the part by analyzing a direction of maximum principal stress for elements of the part to be printed subject to tension under the load. The method also includes, at 600, the act of determining a printing direction for the part or elements of the part by analyzing a direction of minimum principal stress (or maximum of the absolute principal stress) for elements of the part to be printed subject to compression under the load. In one example, the act 600 of determining can be performed after the act 500 of generating the print location instructions has been completed. The act of analyzing a direction of maximum or minimum principal stress (or the maximum of the absolute principal stress) for elements of the part to be printed subject to tension and compression respectively under the load can be performed by executing a subroutine developed by the user in the finite element analysis software (e.g., Abaqus®).

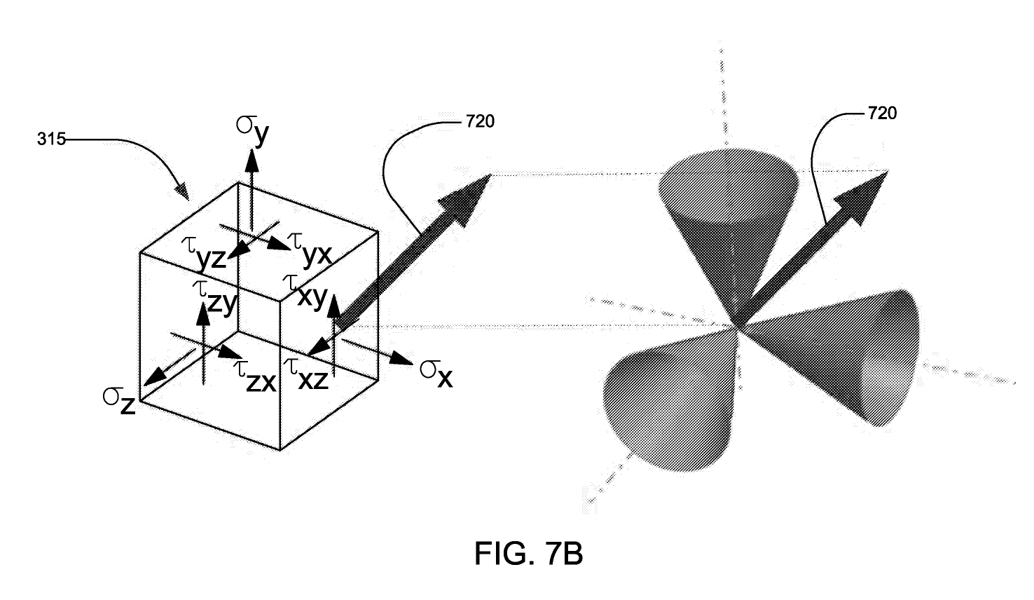

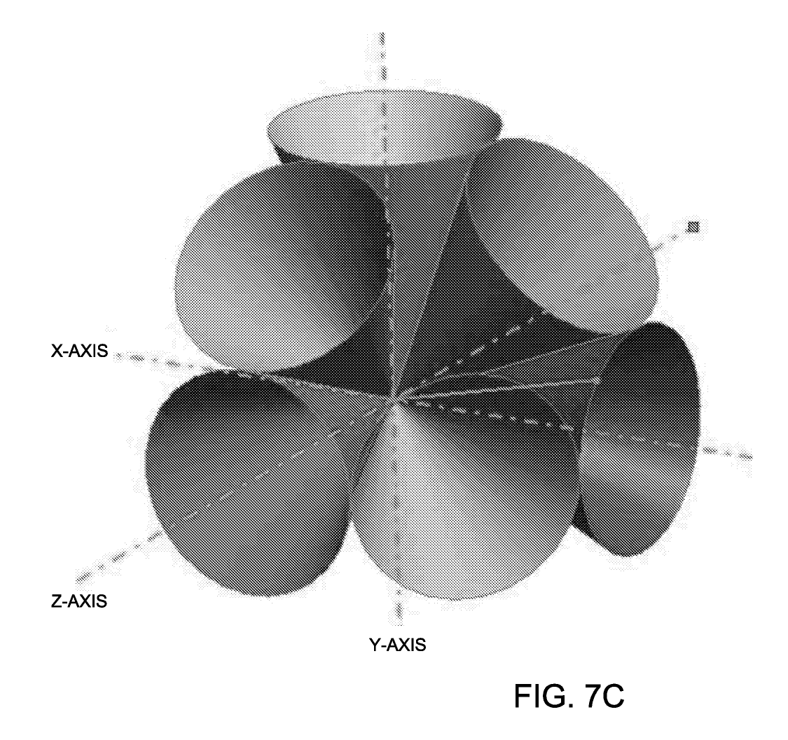

FIG. 6 illustrates a stress analysis for the part showing the relative mapped directions of maximum principal stress for elements of the part under tension and compression. As shown in this FIG., which is purely exemplary, a majority of the mapped directions are located in the L direction (i.e., aligned with the X-axis) (at 610). Mapped directions that are aligned with the Y-axis 620, Z-axis 630, 45 degrees 640 and those under compression 650 are also shown. FIG. 6A is a top perspective view of a stress analysis for the part showing a dissected view of the illustration of FIG. 6, with each of the mapped directions aligned with each axis (X, Y, Z and 45 degrees) shown individually.

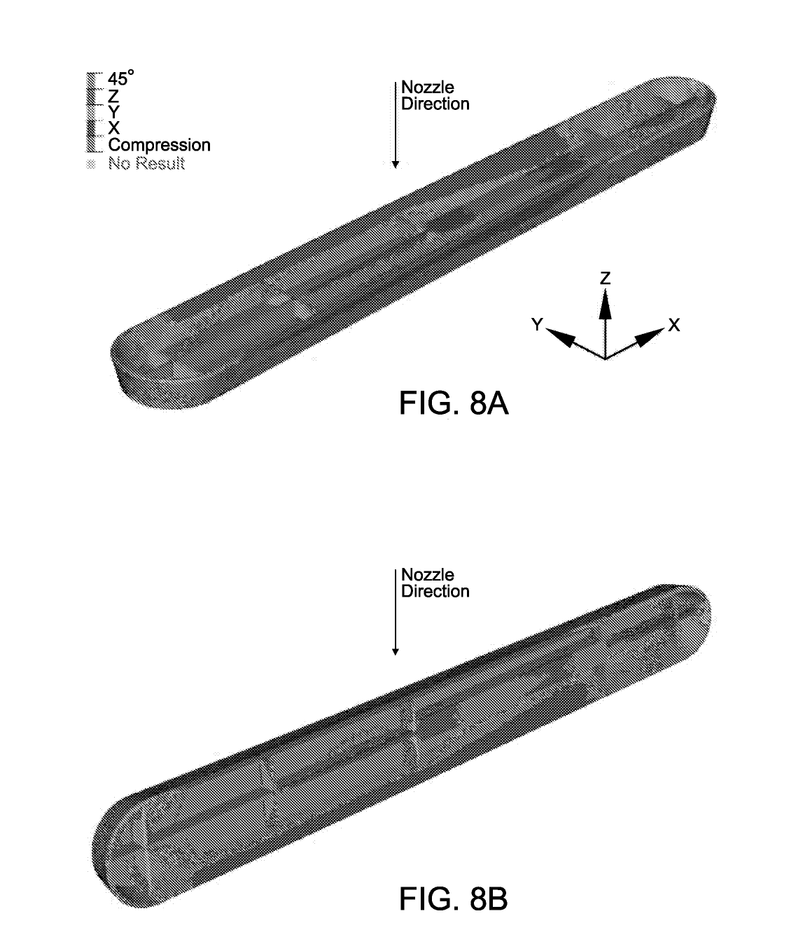

The process for determining the mapped direction based on the relative direction of maximum principal stress for elements of the part is further illustrated in FIGS. 7A and 7B, which show an exemplary element 315 in the part to be printed 310. Principal stresses for each of the elements 315 in the L, A and T direction (corresponding to the direction of the X-axis, Y-axis and Z-axis, respectively) are determined for the part to be printed 310, and the direction having the maximum principal stress determines the direction of maximum principal stress 720 for that element 315. For example, referring also to FIG. 7A, for an element 315 in tension, if the direction of maximum principal stress 720 for the element 315 lies within a tolerance cone of 22.5 degrees about the X-axis (i.e., in the L direction), then the element 315 is mapped to be printed along the X-axis. If the direction of maximum principal stress 720 for that element 315 is not within this tolerance cone for the X-axis, then the direction of maximum principal stress 720 is evaluated to determine whether the direction lies within a tolerance cone of 22.5 degrees about the Y-axis; if it does then the element 315 is mapped to be printed along the Y-axis (i.e., in the A direction). If the direction of maximum principal stress 720 for that element 315 is not within the tolerance cones for the X-axis or Y-axis, then the direction of maximum principal stress 720 is evaluated to determine whether the direction lies within a tolerance cone of 22.5 degrees about the Z-axis; if it does then the element 315 is mapped to be printed along the Z-axis (i.e., in the T direction). If the direction of maximum principal stress 720 for that element 315 is not within the tolerance cones for any of the X, Y or Z axes, then the direction of maximum principal stress 720 would lie in a direction that is between 22.5 degrees of one axis and 22.5 degrees of the other axes (i.e., between 22.5 degrees and 67.5 degrees). In such an instance, the element with this angle of maximum principal stress 720 is mapped at 45 degrees. This example is illustrated in FIG. 7B.

Elements 315 of the part in tension are thus mapped to be printed along the X-axis, Y-axis, Z-axis or at 45 degrees. In certain aspects, for elements under compression, the mapping will be in a direction perpendicular to the direction of minimum principal stress (or the maximum of the absolute principal stress), as intuitively the performance would be reverse for an element in compression.

While the tolerance cone has been described above as having an angle of 22.5 degrees, and the direction of maximum principal stress for the elements 315 is mapped into one of four directions (along the X-axis, Y-axis, Z-axis or at an angle of 45 degrees), it will be understood that the angle of the tolerance cone can be greater than or less than 22.5 degrees and the number of directions in which the elements 315 are mapped can be increased or decreased. For instance, in one aspect the element 315 can be analyzed along only the X-axis, Y-axis and Z-axis using a tolerance cone of 45 degrees. In another aspect, the tolerance cone angle can be between about 0.5 degrees and about 45 degrees, and the number of directions in which the elements 315 are mapped can be increased, as illustrated in FIG. 7C. Increasing the number of directions in which the maximum principal stress 720 for the element 315 is mapped and decreasing the tolerance cone angle for each direction accordingly would improve the accuracy of the mapping of the printing direction for that element 315.

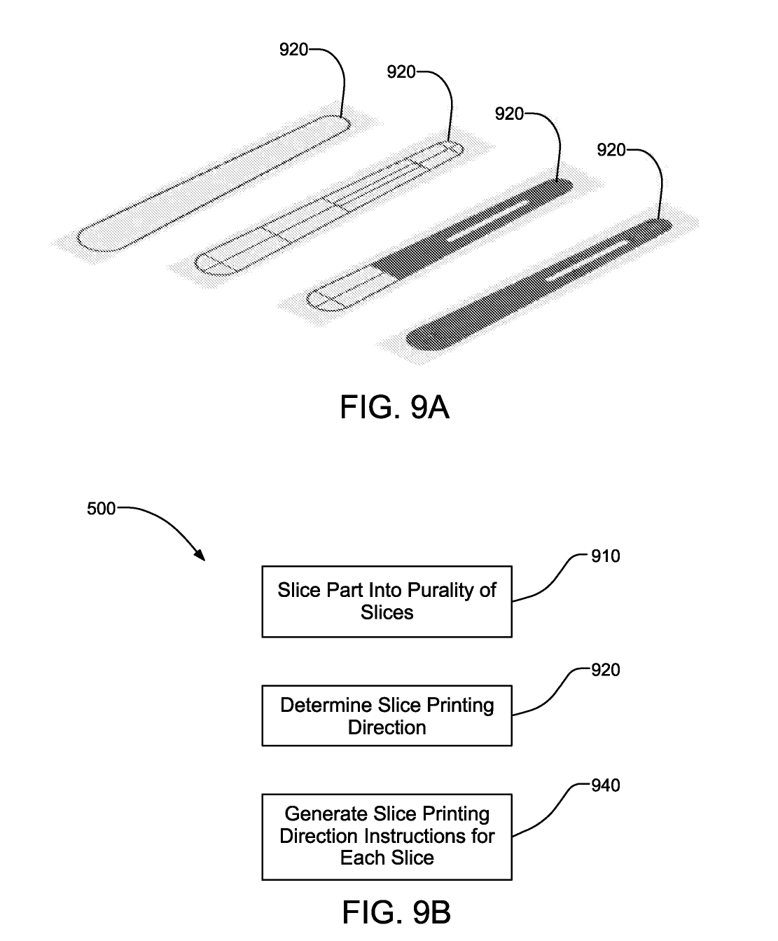

After the direction of printing for the elements 315 is determined, in one aspect the directions of maximum principal stresses 720 for all elements 315 can be averaged or weight-averaged to determine a direction of printing for the part. For example for the part illustrated in FIG. 6 having elements of maximum principal stress oriented primarily in the L-direction (i.e., along the X-axis), the averaged or weight-averaged direction of maximum principal stress for the part is in the L-direction. This is illustrated in FIGS. 8A and 8B, in which the part is configured to be printed in the L-direction in either of the alignments shown, with FIG. 8A showing the part being printed starting from the bottom of the part (which would not require support material for the part as it is printed but which would take up more surface area/space on the print bed), and FIG. 8B showing the part being printed starting from its side (which could require support material but which would take up less space on the print bed). It will be recognized that while the directions of maximum principal stress 720 for all elements 315 in the part can be averaged to determine the direction of printing for the part 10, they need not be averaged; rather, the part 10 may be printed in whatever direction is determined for that element 315 or group of elements 315, and the direction of printing may be adjusted as elements 315 having different mapped directions based on the maximum principal stress 720 are printed.

The present disclosure recognizes that fibers in composite materials tend to align in the direction of printing. Accordingly, the acts of determining the direction of printing for the elements, and for the printed part 10, and then printing the part in the direction of printing, results in a part that has a higher strength and/or stiffness than one in which no analysis and determination of printing direction has been made. Further, as discussed above, fibers in composite materials have a higher strength and/or stiffness in tension than in compression. Thus, by printing the part in the direction of maximum principal stress, the fibers in the composite material in the part will substantially align in that direction as well, which will further increase the overall strength and/or stiffness of the printed part 10.

After the print direction instructions have been generated at act 700, the method 100 can include the act of routing the print location and print direction instructions to the controller 1070 of the additive manufacturing system 1000. This is graphically illustrated in FIGS. 1 and 10A at act 800. For instance, the print location instructions 500 and print direction instructions 700 can be individually routed to the controller 1070 as they are generated. Accordingly, print location instructions generated at act 500 and the print direction instructions generated at act 700 can be sent to the controller 1070 at different times. Alternatively, the print location instructions 500 and print direction instructions 700 can be simultaneously routed to the controller 1070.

The acts to the method described herein, and in particular the acts described at one or more of 300, 400, 500 and 600, can be performed by one or more techniques programmed into a computer processor using a suitable programming code. In one aspect, the technique(s) is coded into the processor using Abaqus®, a commercial finite element analysis code. Other coding systems can be utilized to perform the acts described herein. In addition, optimization codes such as TOSCA® can be incorporated into the method to obtain a distribution of tensile material 1050 and base material 1060, so that the printed part 10 can be optimized to meet desired performance requirements.

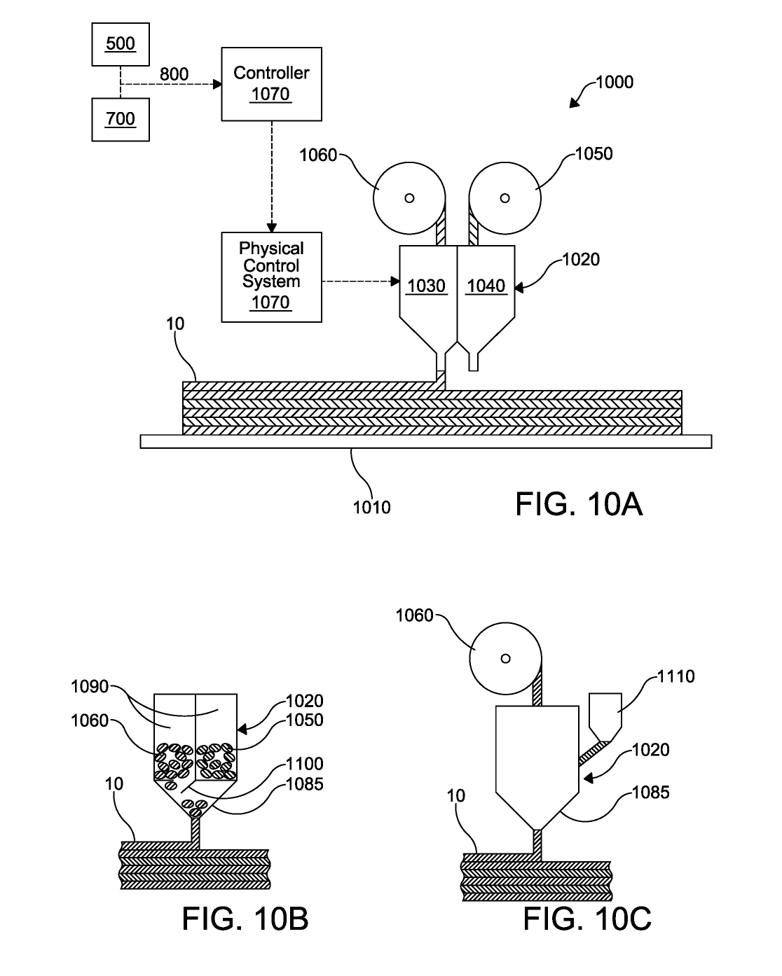

In another aspect of the method, the act of generating print direction instructions 700 can be, but does not have to be, refined at 900. As illustrated in FIGS. 9A and 9B, this act includes, at 910, slicing the part to be printed 310 into a plurality of slices 920 along the printing direction for the part. Individual slices 920 are illustrated in FIG. 9A. As shown, the determined printing direction for the part is along the X-axis (see FIG. 8A and the description set forth above), and individual slices 920 extend from the bottom of the part upwards (i.e., in the Z direction). For each of the plurality of slices, a slice printing direction is determined at 930 by analyzing a direction of maximum principal stress for the elements 315 in the slice 920 subject to tension under the load and the direction of minimum principal stress for the elements 315 in the slice 920 subject to compression under the load. At 940 slice printing direction instructions are generated for each slice, the slice printing direction instructions 940 including instructions to print the slice 920 in the slice printing direction 930. By determining a printing direction for each slice 920 and adjusting that direction as each slice 920 is printed, fibers in the composite material (tensile material 1050) can be aligned in the printing direction 930 determined for that slice 920, rather than in just the printing direction determined for the overall printed part 10. In other aspects, the printing direction for each slice 920 is determined, but the printing direction is not adjusted as each slice 920 is printed; rather, the printing directions for each slice 920 are averaged or otherwise normalized to determine an overall printing direction for the part and the part is printed in the overall printing direction.

The additive manufacturing system for printing the part in accordance with the instructions described above will now be described. With reference to FIG. 10A, in one aspect the additive manufacturing system 1000 includes a print bed 1010 on which a printed part 10 is formed and a print head/nozzle system 1020 that provides the material onto the print bed that forms the printed part 10. In one aspect the print head/nozzle system 1020 includes at least one print head and nozzle 1030. As shown in FIG. 10A, the print head/nozzle system 1020 includes two print heads and nozzles 1030, 1040. The print head/nozzle system 1020 is configured to apply at least two materials onto the print bed 1010, a tensile material 1050 and a base material 1060, according to the print location instructions 500. As discussed above, print location instructions 500 and print direction instructions 700 are routed 800 to the controller 1070, and the controller 1070 operates a physical control system 1080 that moves the print head/nozzle system 1020 relative to the print bed 1010. In this manner, the print bed 1010, print head/nozzle system 1020, controller 1070 and physical control system 1080 operate to form the printed part 10 from the materials.

As noted above, in one aspect the print head/nozzle system 1020 includes at least one print head and nozzle 1030, such as two print heads and nozzles 1030, 1040 as shown in FIG. 10A. In another aspect, the print head/nozzle system includes one print head and nozzle 1085, as shown in FIG. 10B. The print head and nozzle 1085 includes at least two hoppers 1090 into which the materials, such as the tensile material 1050 and base material 1060 can be preloaded. A switch 1100 operates to control which material (e.g., tensile material 1050 or base material 1060) exits the print head and nozzle and is applied onto the printed part 10. In a further aspect, as shown in FIG. 10C, the print head/nozzle system 1020 includes one print head and nozzle 1085, but instead of having both a tensile material 1050 and a base material 1060 preloaded therein, the print head/nozzle system 1020 includes a base material 1060 and a reservoir 1110 of a material, such as glass or carbon fibers, that may be compounded with the base material 1060 within the print head to form the composite material (tensile material) as demanded by the print head/nozzle system 1020.

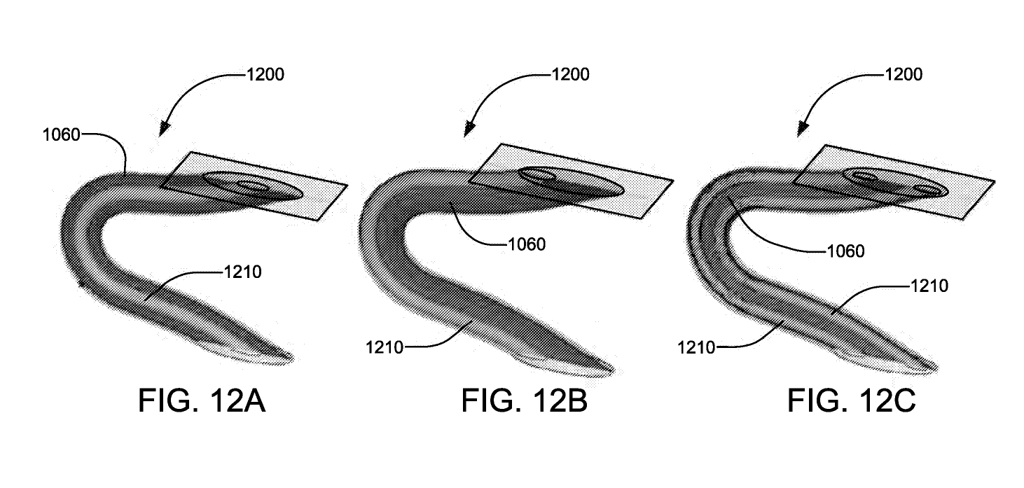

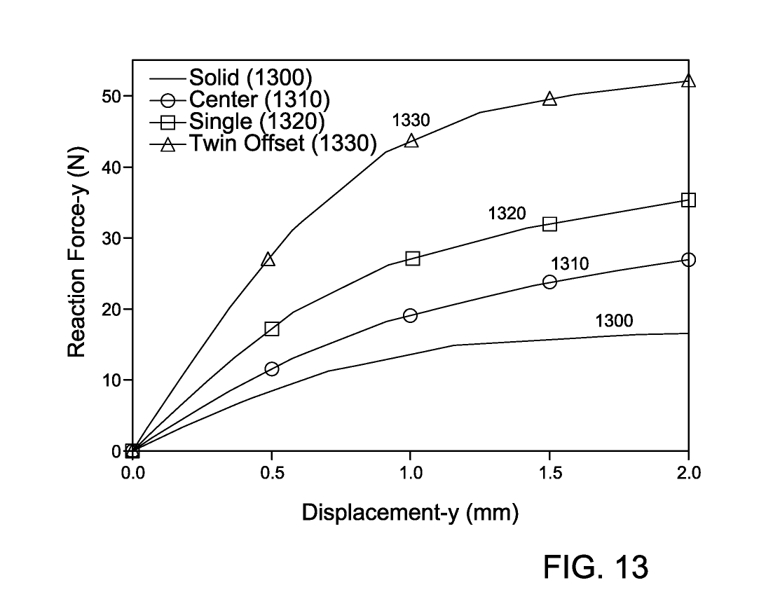

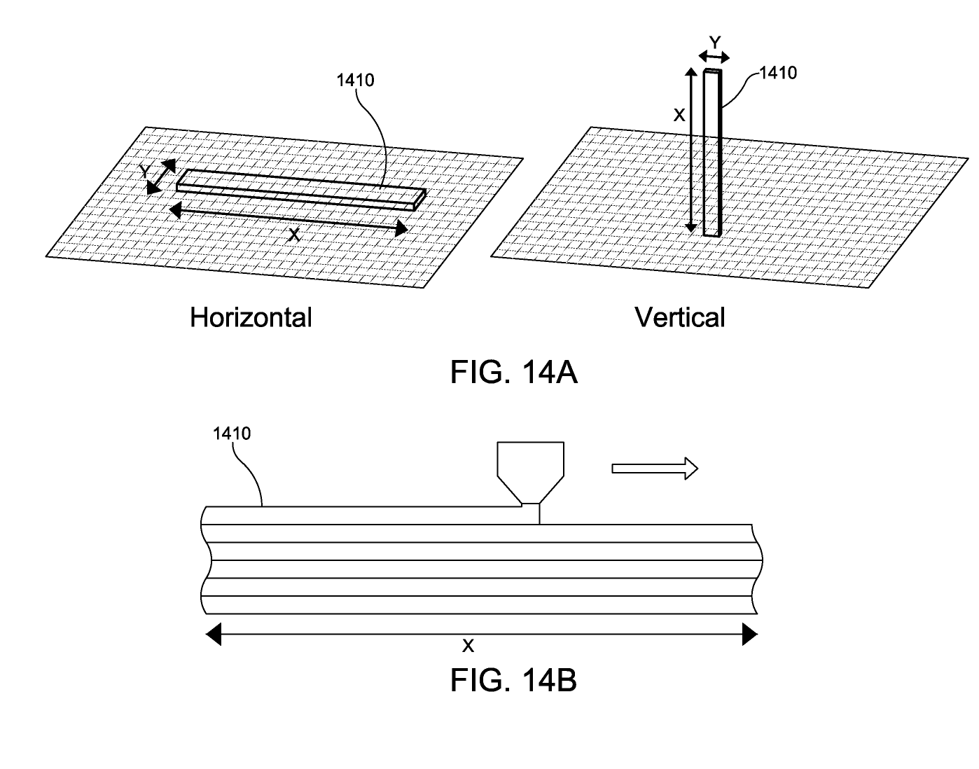

In a further aspect, the manufacturing method 100 described herein can be incorporated for a continuous glass, carbon, polymeric (e.g., ABS) or metal fiber printing. With reference to FIG. 11, a spring 1200 made with a base material (e.g., PEI resin, polycarbonate, nylon or semi-crystalline thermoplastic) 1060 is illustrated as being loaded in compression. The elements of the part to be printed (spring 1200) under tension and compression and the printing direction can be determined according to methods described herein. With reference to FIGS. 12A-C, options for incorporating a continuous fiber 1210 into the part can be considered, in which the part includes: a single continuous fiber 1210 aligned in the center of the part (FIG. 12A); a single continuous fiber 1210 offset to one side of the part subject to tension (FIG. 12B); and two continuous fibers 1210 offset to two sides of the part subject to tension (FIG. 12C). With reference to FIG. 13, it is observed that the load displacement curve in the case of a single continuous fiber 1210 offset to one side of the part 1310 under tension is better/higher than that having a single continuous fiber 1210 aligned in the center of the part 1320, because the single continuous fiber passes through elements under tension (FIG. 11A). Further, the example in which two continuous fibers 1210 are inserted into the part and offset to the sides subject to tension 1330 (FIG. 12C) provides the best performance, because each continuous fiber 1210 reinforces elements of the part subject to tension. Parts including a continuous fiber 1210 such as those described herein can be formed by printing the base material 1060 and laying the continuous fiber 1210 in the determined location(s) into the part as it is printed according to methods known in the art. In some aspects the continuous fiber 1210 is an individual fiber, bundles of fibers, or fibers impregnated in a base resin. The composition and quantity of continuous fibers 1210 may be determined by the performance requirements of the part under the load.

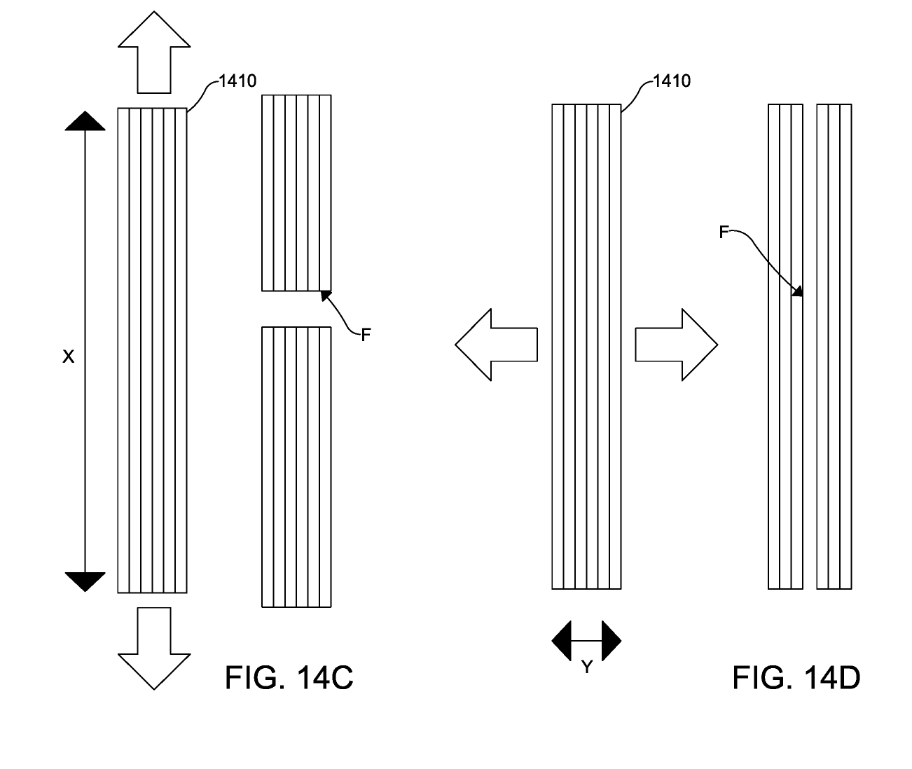

In certain aspects, the manufacturing method 100 can be applied to determine the printing direction for a printed part 10 in instances where the printing material is homogeneously applied to the part (i.e., where a only one of a tensile material or base material is applied to the part). FIGS. 14A-D illustrate a method for determining the printing direction of a part so as to maximize its strength and/or stiffness. As shown in FIG. 14A, an exemplary part 1410 having a length X and width Y may be printed either horizontally or vertically. When printed horizontally (see FIG. 14B), the print head and nozzle prints a first layer along the length X of the part 1410, and then prints additional layers (second, third, etc. layers) along the length X of the part according to known additive manufacturing techniques. When printed vertically (not shown), the print head and nozzle prints a first layer along the width Y of the part 1410, and then prints additional layers (second, third, etc. layers) along the width Y of the part according to known additive manufacturing techniques. With this in mind, the manufacturing method 100 described above can be applied to identify regions of the part 1410 that will be under tension and compression and the printing direction for the part can be determined. If, for example, the part will be subjected to tension along its length X (see FIG. 14C), it will have a higher tensile strength, stiffness and/or elongation to break than if it will be subjected to tension along its width Y (see FIG. 14D). This is because the bond between successive layers in the part is not as strong as the bond within the layer. As a result, the part should be printed along its length X as shown. If, however, the part will be subjected to tension along its width Y (FIG. 14D), the part should be printed vertically (along its width Y) so that its tensile strength and stiffness will be higher in the direction of its width Y. This method can be applied regardless of the type of material that is used to print the part: neat, composite, etc.

Further, this method can be applied when the part will be subjected to compression, although it is believed that the direction of printing would be the reverse of the example described above for a part in tension, because if compression is applied to the part along its length X, the part could buckle, causing the layers of the part to separate if it were printed along its length X. As a result, it is believed that a part that will be subjected to compression along its length X should be printed vertically, so that the layers of the part would be perpendicular to the compression force. The direction of printing for a simple part can be visualized using the process above. For complex components, the mapping method described above is based on analyzing the directions of maximum and minimum principal stresses (or maximum of absolute principal stresses) for regions in tension and compression respectively. This would provide a direction of printing for the individual elements in the finite element model, individual slices or the entire part.

Accordingly, aspects of aspect of the present disclosure include a manufacturing method 100 for manufacturing a printed part 1410, the method including:

a) applying a finite element analysis 300 to the part 1410 under a load;

b) identifying elements of the part 1410 subject to tension and compression under the load;

c) determining a printing direction 600 for the part 1410 or elements of the part 1410 based on the identification step performed at b);

d) generating print direction instructions 700 for the part 1410, the print direction instructions 700 including instructions to print the part 1410 in the determined printing direction 600; and

e) printing the part in a manufacturing system in accordance with the print direction instructions 700.

Aspects of the manufacturing method 100 described herein can be incorporated into applications other than those described above. In some aspects, methods described herein can be used to determine a direction of printing in fused filament fabrication (e.g., fused deposition modeling) processes, such as the X-TECH™ process used by Inxide AB. In such processes, a pre-form of continuous fibers is designed and produced, which is then over-molded (e.g., injection molded) using traditional injection processes. The pre-form reinforces the injection molded part. The manufacturing method 100 described herein could be used to identify regions in the molded part that are subject to tension and compression. The shape of the pre-form could be tailored based on the identified regions of tension and compression, with the continuous fibers laid only in regions in the molded part that are subject to tension. Further, printing directions for the pre-form could be determined in order to strengthen it.

In other aspects, the manufacturing method can be used in tailored fiber placement processes such as those used by LayStitch™ Technologies. In current processes utilizing these technologies, topology optimization is used to determine the fiber locations for a part. As an alternative to topology optimization techniques, the manufacturing method 100 according to aspects described herein could be used to identify regions in the part subject to tension and compression, and the fiber locations for the part, and the direction of laying the fiber in the part, can be tailored based on the identified regions of tension and compression.

Additional manufacturing methods in which aspects of the disclosure could be incorporated include, but are not limited to, selective laser sintering (SLS) methods and stereo lithography (SLA) methods.

Accordingly, aspects of aspect of the present disclosure include methods for manufacturing a reinforced part, the reinforcement being a fiber, filament, pre-form or other suitable reinforcement, the method including:

a) applying a finite element analysis to the part under a load;

b) identifying elements of the part subject to tension and compression under the load;

c) determining a printing direction for the reinforcement based on the identification step performed at b);

d) generating print location instructions and/or print direction instructions for the part, the print location instructions and/or print direction instructions including instructions to form the reinforcement in accordance with the determined print location instructions and/or the determined print direction instructions; and

e) forming the reinforcement in accordance with the print location instructions and/or the print direction instructions.

The reinforcement could be formed prior to forming the printed part (such as when used with fused deposition modeling processes) or could be formed as the part is being made or even after the part has been made (such as when used with tailored fiber placement processes).

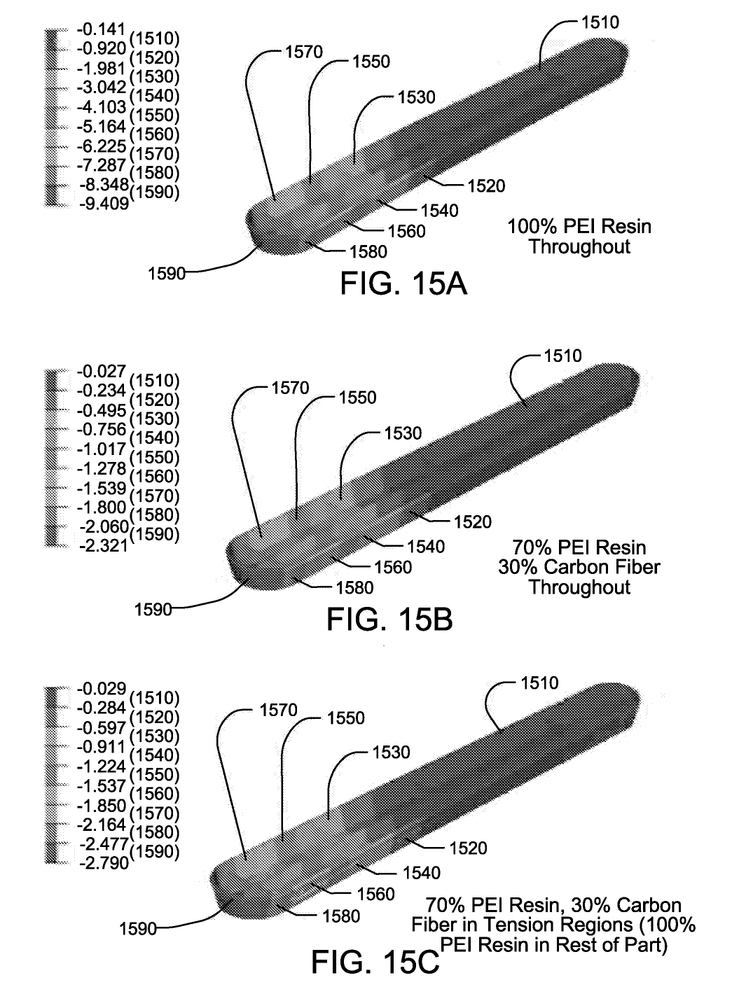

FIGS. 15A-C provide displacement data for parts made from various materials. The part in FIG. 15A includes 100% PEI resin (Ultem™ resin) throughout the part. Maximum displacement of the part is 9.409 mm (at 1590). The part in FIG. 15B includes 70% Ultem™ resin and 30% carbon fiber throughout. Maximum displacement of the part is 2.321 mm (at 1590). The part in FIG. 15C is a hybrid part that includes a composite (70% Ultem™ resin and 30% carbon fiber referred to as the carbon fiber filled material) applied only in regions subject to tension and 100% Ultem™ resin located in other regions (including those regions subject to compression). This part has only 39% of the carbon fiber filled material as the one in FIG. 15B. Maximum displacement of the part is 2.790 mm (at 1590). The hybrid part formed according to embodiments of the present disclosure (i.e., the part of FIG. 15C) thus has a displacement that compares favorably to the one that includes carbon fiber throughout (FIG. 15B), but includes only a fraction of the carbon fiber, resulting in a substantial cost savings.

While the manufacturing method 100 described herein includes a series of acts (e.g., 200, 300, 400, 500, 600, 700 and 800), these acts need not necessarily be carried out in the order described herein. Purely by way of example, in one aspect the acts of determining the printing direction 600 and generating print direction instructions 700 can be performed prior to the act of generating print location instructions 500.

It should be appreciated that the present disclosure can include any one up to all of the following examples:

### Example 1

A method for manufacturing a printed part, the method comprising:

generating print location instructions for the part, the print location instructions comprising:
instructions to apply a tensile material to elements of the part corresponding to elements of a part to be printed subject to tension under a load, and
instructions to apply at least a base material to other elements of the part;

determining a printing direction for the part or elements of the part by analyzing:
a direction of maximum principal stress for elements of the part to be printed subject to tension under the load, and
a direction of minimum principal stress for elements of the part to be printed subject to compression under the load;

generating print direction instructions for the part, the print direction instructions comprising instructions to print the part in the determined printing direction; and

printing the part in a manufacturing system in accordance with the print location instructions and print direction instructions.

### Example 2

The method according to example 1, comprising:

applying a finite element analysis to the part under the load;

identifying elements of the part subject to tension and compression under the load; and

routing the print location instructions and print direction instructions to the manufacturing system.

### Example 3

The method according to example 1 or 2, wherein the manufacturing system comprises:

a print bed;

a print head/nozzle system comprising at least one print head and nozzle, the print head/nozzle system configured to apply at least two materials onto the print bed, the at least two materials comprising the tensile material and the base material;

a physical control system for moving the print head/nozzle system relative to the print bed; and

a controller for receiving the print location instructions and print direction instructions.

### Example 4

The method according to example 1, wherein generating print direction instructions comprises:

slicing the part to be printed into a plurality of slices along the printing direction for the part;

determining, for each of the plurality of slices, a slice printing direction by:
analyzing a direction of maximum principal stress for each of the elements of the slice subject to tension under the load, and
analyzing a direction of minimum principal stress for each of the elements of the slice subject to compression under the load; and

generating slice printing direction instructions for each slice, the slice printing direction instructions comprising instructions to print the slice in the determined slice printing direction.

### Example 5

The method according to example 2, comprising identifying elements of the part to be printed subject to tension and compression under the load.

### Example 6

The method according to any of the previous examples, wherein the print location instructions comprise instructions to apply a base material to elements of the part subject to compression under the load.

### Example 7

The method according to any of the previous examples, wherein the tensile material comprises a composite, the composite comprising carbon fibers, glass fibers, metal fibers or combinations thereof in a substrate material.

### Example 8

The method according to example 7, wherein the substrate material comprises a polymeric material, metallic material, ceramic material, or a combination thereof.

### Example 9

The method according to any of the previous examples, wherein the base material comprises polycarbonate, nylon, glass fiber, amorphous thermoplastic polyetherimide (PEI) resin or semi-crystalline thermoplastic.

### Example 10

The method according to any one of examples 3 or 6-9, wherein the print head/nozzle system comprises at least a first print head and nozzle and a second print head and nozzle, the tensile material is applied by the first print head and nozzle, and the base material is applied by the second print head and nozzle.

### Example 11

The method according to any one of examples 3 or 6-9, wherein the print head/nozzle system comprises one print head and nozzle.

### Example 12

A printed part made according to the method of any one of examples 1 to 11.

### Example 13

The printed part of example 12, wherein the part is a spring.

### Example 14

A manufacturing method for manufacturing a printed part, the method comprising:

determining a printing direction for the part or elements of the part by analyzing
a direction of maximum principal stress for elements of the part to be printed subject to tension under the load, and
a direction of minimum principal stress for elements of the part to be printed subject to compression under the load;

generating print direction instructions for the part, the print direction instructions comprising instructions to print the part in the determined printing direction, wherein generating print direction instructions comprises:
slicing the part to be printed into a plurality of slices along the printing direction for the part;
determining, for each of the plurality of slices, a slice printing direction by analyzing
   a direction of maximum principal stress for the elements of the slice subject to tension under the load, and
   a direction of minimum principal stress for elements of the slice subject to compression under the load; and
generating slice printing direction instructions for each slice, the slice printing direction instructions comprising instructions to print the slice in the determined slice printing direction; and

printing the part in a manufacturing system in accordance with the print direction instructions.

### Example 15

The method of example 14, comprising generating print location instructions for the part, the print location instructions comprising:

instructions to apply a tensile material to elements of the part corresponding to elements of the part to be printed subject to tension under the load; and

instructions to apply at least a base material to other elements of the part.

### Example 16

The method according to examples 14 or 15, comprising:

applying a finite element analysis on the part to be printed under the load;

routing the print location instructions or print direction instructions to the manufacturing system.

### Example 17

The method according to any one of examples 14 to 16, wherein the manufacturing system comprises:

a print bed;

a print head/nozzle system comprising at least one print head and nozzle;

a physical control system for moving the print head/nozzle system relative to the print bed; and

a controller for receiving the print location instructions or print direction instructions.

### Example 18

The method according to any one of examples 14 to 17, comprising identifying elements of the part to be printed subject to tension and compression under the load.

### Example 19

The method according to any one of examples 15 to 18, wherein the print location instructions comprise instructions to apply the base material to elements of the part corresponding to elements of the part to be printed subject to compression under the load.

### Example 20

The method according to any one of examples 15 to 19, wherein the tensile material comprises a composite, the composite comprising carbon fibers, glass fibers, metal fibers or combinations thereof in a substrate material.

### Example 21

The method according to example 20, wherein the substrate material comprises a polymeric material, metallic material, ceramic material, or a combination thereof.

### Example 22

The method according to any one of examples 15 to 21, wherein the base material comprises polycarbonate, nylon, glass fiber, amorphous thermoplastic polyetherimide (PEI) resin or semi-crystalline thermoplastic.

### Example 23

The method according to any one of examples 17 to 22, wherein the print head/nozzle system comprises at least a first print head and nozzle and a second print head and nozzle, the tensile material is applied by the first print head and nozzle, and the base material is applied by the second print head and nozzle.

### Example 24

The method according to any one of examples 17 to 22, wherein the print head/nozzle system comprises one print head and nozzle.

### Example 25

A printed part made according to the method of any one of examples 14 to 24.

### Example 26

The printed part of example 25, wherein the part is a spring.

### Example 27

A manufacturing system for printing a part, comprising:

a print bed;

a print head/nozzle system comprising at least one print head and nozzle, the print head/nozzle system configured to apply at least two materials onto the print bed, the at least two materials comprising a tensile material and a base material;

a physical control system for moving the print head/nozzle system relative to the print bed;

a controller; and

an analysis system for providing instructions to the controller, the analysis system configured to:
generate print location instructions for the part, the print location instructions comprising
   instructions to apply a tensile material to elements of the part corresponding to elements of a part to be printed subject to tension under a load; and
   instructions to apply at least a base material to other elements of the part;
determine a printing direction for the part by analyzing
   a direction of maximum principal stress for elements of the part to be printed subject to tension under the load, and
   a direction of minimum principal stress for elements of the part to be printed subject to compression under the load; and
generate print direction instructions for the part.

### Example 28

The system of example 27, wherein the analysis system is configured to:

apply a finite element analysis on the part to be printed under the load;

identify elements of the part to be printed subject to tension and compression under the load; and

route the print location instructions and print direction instructions to the controller.

### Example 29

The system according to example 27 or 28, wherein the analysis system is configured to:

slice the part to be printed into a plurality of slices along the printing direction for the part;

determine, for each of the plurality of slices, a slice printing direction by analyzing
a direction of maximum principal stress for each of the elements of the slice subject to tension under the load, and
a direction of minimum principal stress for each of the elements of the slice subject to compression under the load; and

generate slice printing direction instructions for each slice, the slice printing direction instructions comprising instructions to print the slice in the determined slice printing direction.

### Example 30

The system according to example 28 or 29, wherein the analysis system is configured to identify elements of the part to be printed subject to tension and compression under the load.

### Example 31

The system according to any one of examples 27 to 30, wherein the print location instructions comprise instructions to apply the base material to elements of the part corresponding to elements of the part to be printed subject to compression under the load.

### Example 32

The system according to any one of examples 27 to 31, wherein the tensile material comprises a composite, the composite comprising carbon fibers, glass fibers, metal fibers or combinations thereof in a substrate material.

### Example 33

The system according to example 32, wherein the substrate material comprises a polymeric material, metallic material, ceramic material, or a combination thereof.

### Example 34

The system according to any one of examples 27 to 33, wherein the base material comprises polycarbonate, nylon, glass fiber, amorphous thermoplastic polyetherimide (PEI) resin or semi-crystalline thermoplastic.

### Example 35

The system according to any one of examples 27 to 34, wherein the print head/nozzle system comprises at least a first print head and nozzle and a second print head and nozzle, the tensile material is applied by the first print head and nozzle, and the base material is applied by the second print head and nozzle.

### Example 36

The system according to any one of examples 27 to 34, wherein the print head/nozzle system comprises one print head and nozzle.

### Example 37

A printed part made according the system of any one of examples 27 to 36.

### Example 38

The printed part of example 37, wherein the part is a spring.

### Example 39

A manufacturing method for manufacturing a printed part, the method comprising:

a) applying a finite element analysis to the part under a load;

b) identifying elements of the part subject to tension and compression under the load;

c) determining a printing direction for the part or elements of the part based on the identification step performed at b);

d) generating print direction instructions for the part, the print direction instructions comprising instructions to print the part in the determined printing direction; and

e) printing the part in a manufacturing system in accordance with the print direction instructions.

### Example 40

A manufacturing method for manufacturing a printed part, the method comprising:

generating print location instructions for the part, the print location instructions comprising:
instructions to apply a continuous fiber to elements of the part corresponding to elements of a part to be printed subject to tension under a load, and
instructions to apply at least a base material to other elements of the part; and

printing the part in a manufacturing system in accordance with the determined print location instructions.

### Example 41

The manufacturing method according to example 40, comprising:

determining a printing direction for the part or elements of the part by analyzing
a direction of maximum principal stress for elements of the part to be printed subject to tension under the load, and
a direction of minimum principal stress for elements of the part to be printed subject to compression under the load;

generating print direction instructions for the part, the print direction instructions comprising instructions to print the part in the determined printing direction; and

printing the part in accordance with the print direction instructions.

### Example 42

The manufacturing method according to example 41, wherein generating print direction instructions comprises:

slicing the part to be printed into a plurality of slices along the printing direction for the part;

determining, for each of the plurality of slices, a slice printing direction by:
analyzing a direction of maximum principal stress for each of the elements of the slice subject to tension under the load, and
analyzing a direction of minimum principal stress for each of the elements of the slice subject to compression under the load; and

generating slice printing direction instructions for each slice, the slice printing direction instructions comprising instructions to print the slice in the determined slice printing direction.

### Example 43

The method or system according to any of the previous examples, wherein the manufacturing system is an additive manufacturing method, a continuous fiber printing method, a fused filament fabrication method, a tailored fiber placement process, a selective laser sintering (SLS) method, or a stereo lithography (SLA) method.

### Example 44

The method according to any of the previous examples, wherein the direction of maximum principal stress for elements in tension and the direction of minimum principal stress for elements in compression are analyzed to be in a direction of at least an X-axis, Y-axis and Z-axis for the element within a tolerance cone and mapped to be printed along the X-axis, the Y-axis or the Z-axis.

### Example 45

The method according to example 44, wherein the tolerance cone comprises an angle of from about 0.5 to about 45 degrees.

### Example 46

The method according to examples 44 or 45, wherein the direction of maximum principal stress for elements in tension and the direction of minimum principal stress for elements in compression are analyzed in additional directions other than those in the direction of the X-axis, the Y-axis and the Z-axis.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed:

1. A method for manufacturing a printed part, the method comprising:
generating print location instructions for the part, the print location instructions comprising:
instructions to apply a tensile material to elements of the part corresponding to elements of a part to be printed subject to tension under a load; and
instructions to apply at least a base material to other elements of the part;
determining a printing direction for the part or elements of the part by analyzing
a direction of maximum principal stress for elements of the part to be printed subject to tension under the load, and
a direction of minimum principal stress for elements of the part to be printed subject to compression under the load;
generating print direction instructions for the part, the print direction instructions comprising instructions to print the part in the determined printing direction; and
printing the part in a manufacturing system in accordance with the print location instructions and print direction instructions.

2. The method according to claim 1, comprising:
applying a finite element analysis to the part under the load;
identifying elements of the part subject to tension and compression under the load; and
routing the print location instructions and print direction instructions to the manufacturing system.

3. The method according to claim 1, wherein the manufacturing system comprises:
a print bed;
a print head/nozzle system comprising at least one print head and nozzle, the print head/nozzle system configured to apply at least two materials onto the print bed, the at least two materials comprising the tensile material and the base material;
a physical control system for moving the print head/nozzle system relative to the print bed; and
a controller for receiving the print location instructions and print direction instructions.

4. The method according to claim 1, wherein generating print direction instructions comprises:
slicing the part to be printed into a plurality of slices along the printing direction for the part;
determining, for each of the plurality of slices, a slice printing direction by
analyzing the direction of maximum principal stress for each of the elements of the slice subject to tension under the load, and
analyzing the direction of minimum principal stress for each of the elements of the slice subject to compression under the load; and
generating slice printing direction instructions for each slice, the slice printing direction instructions comprising instructions to print the slice in the determined slice printing direction.

5. The method according to claim 2, comprising identifying elements of the part to be printed subject to tension and compression under the load.

6. The method according to claim 1, wherein the print location instructions comprise instructions to apply a base material to elements of the part subject to compression under the load.

7. The method according to claim 1, wherein the tensile material comprises a composite, the composite comprising carbon fibers, glass fibers, metal fibers or combinations thereof in a substrate material.

8. The method according to claim 7, wherein the substrate material comprises a polymeric material, metallic material, ceramic material, or a combination thereof.

9. The method according to claim 1, wherein the base material comprises polycarbonate, nylon, glass fiber, amorphous thermoplastic polyetherimide (PEI) resin or semi-crystalline thermoplastic.

10. The method according to claim 3, wherein the print head/nozzle system comprises at least a first print head and nozzle and a second print head and nozzle, the tensile material is applied by the first print head and nozzle, and the base material is applied by the second print head and nozzle.

11. The method according to claim 3, wherein the print head/nozzle system comprises one print head and nozzle.

12. The method according to claim 1, wherein the manufacturing system is an additive manufacturing method, a continuous fiber printing method, a fused filament fabrication method, a tailored fiber placement process, a selective laser sintering (SLS) method, or a stereo lithography (SLA) method.

13. The method according to claim 1, wherein the direction of maximum principal stress for elements in tension and the direction of minimum principal stress for elements in compression are analyzed to be in a direction of at least an X-axis, Y-axis and Z-axis for the element within a tolerance cone and mapped to be printed along the X-axis, the Y-axis or the Z-axis.

14. The method according to claim 13, wherein the tolerance cone comprises an angle of from about 0.5 to about 45 degrees.

15. The method according to claim 13, wherein the direction of maximum principal stress for elements in tension and the direction of minimum principal stress for elements in compression are analyzed in additional directions other than those in the direction of the X-axis, the Y-axis and the Z-axis.

16. A printed part made according to the method of claim 1.
